(19) United States
(12) Patent Application Publication
(10) Pub. No.: US 2006/0168894 A1
(43) Pub. Date: Aug. 3, 2006

(54) Pre-fabricated sliding door assembly

(76) Inventor: Gideon Gorjian, Great Neck, NY (US)

Correspondence Address: MEREDITH & KEYHANI, PLLC, 330 MADISON AVE., 6TH FLOOR, NEW YORK, NY, 10017, US

(21) Appl. No.: 11/048,561

(22) Filed: Feb. 1, 2005

(51) Int. Cl. E05D 15/06

(52) U.S. Cl. 49/410

(57) ABSTRACT

A pre-fabricated door assembly having a first upper track piece having an open indented c-shaped longitudinal channel and at least two attachment devices, a second upper track piece having a first open c-shaped longitudinal channel portion, an open rectangular portion and a second open c-shaped longitudinal channel portion and at least two openings for receipt of the attachment devices; at least two middle support frame pieces; a first bottom track piece having at least two open c-shaped longitudinal channel portions; a second bottom track piece having a left lip, middle doorway portion, right lip; at least one side track piece having an open c-shaped longitudinal channel perpendicularly attached to first upper track piece and first bottom track piece; a door having a wheel assembly attached to the door and the first upper track piece to provide a sliding door.

### BACKGROUND OF THE INVENTION

The present invention generally relates to sliding doors and specifically to pre-fabricated, easy to install sliding doors.

Sliding doors can be very attractive and useful for a number of reasons. Handicapped individuals may find them to alleviate many of the issues that they may incur with the simple task of opening a door. While a conventional door would require pulling the door open while at the same time moving backwards, a sliding door only requires a sliding motion to one side. Similarly, hospitals will find utility in a one handed, automated function while pushing a patient in a stretcher or equipment.

Another advantage of sliding doors is that they take up less room. Because sliding doors do not have a swinging door, there is no need to leave the area adjacent to the doorway free of furniture. This can be very useful in areas where space is a commodity or where swinging doors can interfere with pedestrian traffic. Also, sliding doors provide better insulation properties than swinging doors and excellent structural qualities, and less damage from “slamming.”

Despite the number of advantages that sliding doors provide, swinging doors remain the standard. This is because of the great difficulty and expense associated with their installation. U.S. Pat. No. 6,276,091 discloses a typical sliding door configuration. As shown, there is a substantially rectangular sliding door doorway with a door frame formed by a lower doorway frame member, an upper doorway frame member, a first vertical doorway frame member, a second vertical doorway frame member, numerous other components and the sliding door doorway being between an inside area and an outside area. There is a door slidably received by the upper and lower doorway frame members. The door having a first rectangular door frame with a first vertical door frame member and a second vertical door frame member. The first vertical door frame member having a coupling passageway formed therein, the second vertical door frame member having a locking passageway formed therein, the first glass door being adapted to slide to a position wherein the first vertical door frame member is in sealed engagement with the first vertical doorway frame member. There may also be additional doors and screens. There is also a a coupling member operably received in the door frame member such that the coupling member can engage the coupling passageway when a glass door is in a particular position.

The '091 patent makes clear one of the problems with the prior art. The problem is the number of door jambs and working parts that are required to provide a sliding door. A door jamb consists of at least a top and two sides, and usually many more sides and parts. The '091 patent also includes screws, bolts and numerous other components requiring tools and construction acumen. The lack of need for heavy power tools also makes the present invention safer. Each of these sides and parts adds complexity to the project and generally requires the time of a handyman or contractor, which can be expensive, and ultimately, cost prohibitive. It is a purpose of the present invention to provide a very easy to use, easy to install item that has very few parts. As such, it requires very little time to install.

While prior art sliding doors serve their specific purposes, no inventor has yet come up with a sliding door assembly that is pre-fabricated, easy to install has fewer functioning/moving parts, does not require special building tools, is not dangerous for employees to use, is pre-set for common sheet rock widths, is incorporated into the structure of the house or other building, may be directly flush with the wallboard and does not require a door jamb. The present invention is also pre-sized and pre-fitted for onsite sheet rock construction.

### SUMMARY OF THE INVENTION

The present invention provides a pre-fabricated, easy to install sliding door that is flush with the wall and does not require a door jamb, or numerous building tools.

According to one embodiment, a pre-fabricated sliding door assembly is disclosed, the door assembly comprising: a first upper track piece having an open indented c-shaped longitudinal channel and at least two attachment devices; a second upper track piece having a first open c-shaped longitudinal channel portion, an open rectangular portion and a second open c-shaped longitudinal channel portion and at least two openings for receipt of the attachment devices; at least two middle support frame pieces each having a first open rectangular channel and a second open rectangular channel, the opening of the first open rectangular channel being parallel to the opening of the second open rectangular channel; a first bottom track piece having at least two open c-shaped longitudinal channel portions; a second bottom track piece with a left lip, middle doorway portion, right lip, wherein the left lip and said right lip are perpendicular to the middle doorway portion; at least one side track piece, wherein the at least one side track piece has an open c-shaped longitudinal channel, and each side track piece is perpendicularly attached to the first upper track piece and the first bottom track piece; a door having a wheel assembly fixedly attached along the top of the door; wherein each of the middle support frame pieces are fixedly attached between the first upper track piece, first bottom track piece and second bottom track piece, wherein each at least one side track piece is fixedly attached between the first upper track piece and a bottom track piece, wherein the first upper track piece receives said wheel assembly slides along said first upper track piece and between said at least two middle support frame piece to provide a sliding door.

According to another embodiment, a pre-fabricated sliding door assembly is disclosed, comprising: a first upper track piece having an open indented c-shaped longitudinal channel and at least two attachment devices that are raised shaped cut-outs; a second upper track piece having a first open c-shaped longitudinal channel portion, an open rectangular portion and a second open c-shaped longitudinal channel portion and at least two openings for receipt of the attachment devices; at least two middle support frame pieces each having a first open rectangular channel and a second open rectangular channel, the opening of the first open rectangular channel being parallel to the opening of the second open rectangular channel and of a dissimilar size opening; a first bottom track piece, having at least two open c-shaped longitudinal channel portions; a second bottom track piece, the second bottom track piece has a left lip, middle doorway portion, right lip, the left lip and right lip are perpendicular to the middle doorway portion; each side track piece has an open c-shaped longitudinal channel and at least one tongue shaped cut out, and each side track piece is perpendicularly attached to the first upper track piece and the first bottom track piece; a door having a wheel assembly fixedly attached along the top of the door; at least one wall panel, wherein one side of the wall panel is contained within the first open rectangular channel to form a wall; each middle support frame pieces is fixedly attached between the first upper track piece, the first bottom track piece and the second bottom track piece, wherein each at least one side track piece is fixedly attached between the first upper track piece and a bottom track piece, and wherein the first upper track piece receives the wheel assembly slides along the first upper track piece and between the middle support frame pieces to provide a sliding door.

According to yet another embodiment, a pre-fabricated sliding door assembly, the door assembly comprising: a first upper track piece having an open indented c-shaped longitudinal channel and at least two attachment devices, wherein at least two attachment devices are raised shaped cut-outs; a second upper track piece having a first open c-shaped longitudinal channel portion, an open rectangular portion and a second open c-shaped longitudinal channel portion and at least two openings for receipt of the at least two attachment devices; at least two middle support frame pieces each having a first open rectangular channel and a second open rectangular channel, the opening of the first open rectangular channel being parallel to the opening of the second open rectangular channel and of a dissimilar size opening; a first bottom track piece, the first bottom track piece having at least two open c-shaped longitudinal channel portions; a second bottom track piece which has a left lip, middle doorway portion and right lip, wherein the left lip and right lip are perpendicular to the middle doorway portion; at least one side track piece having an open c-shaped longitudinal channel and at least one tongue shaped cut out, and wherein each at least one side track piece is perpendicularly attached to the first upper track piece and the first bottom track piece; at least one bumper along at least one side track piece; a door having a wheel assembly fixedly attached along the top of the door, the wheel assembly comprised of at least one wheel and a hanging wheel attachment means; at least one tongue shaped metal attachment device; at least one wall panel, wherein at one side of the wall panel is contained within the first open rectangular channel to form a wall; wherein each middle support frame piece is fixedly attached between the first upper track piece, first bottom track piece and second bottom track piece, wherein each side track piece is fixedly attached between the first upper track piece and a bottom track piece, and wherein the wheel assembly slides along the first upper track piece and between the two middle support frame pieces to provide a sliding door.

This summary is not to be taken in a limiting sense, but is made merely for the purpose of illustrating the general principles of the invention, since the scope of the invention is best defined by the appended claims.

### BRIEF DESCRIPTION OF THE DRAWINGS

FIG. 1 depicts an exploded view according to the present invention;

FIGS. 2A-2D depict a first upper track piece according to the present invention;

FIGS. 3A-3D depict a second upper track piece according to the present invention;

FIGS. 4A-4D depict a middle support frame piece according to the present invention;

FIGS. 5A-5E depict a side track piece according to the present invention;

FIGS. 6A-6D depict a first bottom track piece according to the present invention;

FIGS. 7A-7D depict a second bottom track piece according to the present invention;

FIG. 8 depicts a tongue shaped metal attachment device according to the present invention;

FIG. 9 depicts a door assembly according to the present invention.

FIG. 10 depicts a door assembly according to the present invention;

FIG. 11 depicts a door assembly according to the present invention;

FIG. 12 depicts a door assembly according to the present invention;

FIG. 13 depicts a door assembly according to the present invention; and

FIG. 15 depicts a door assembly according to the present invention.

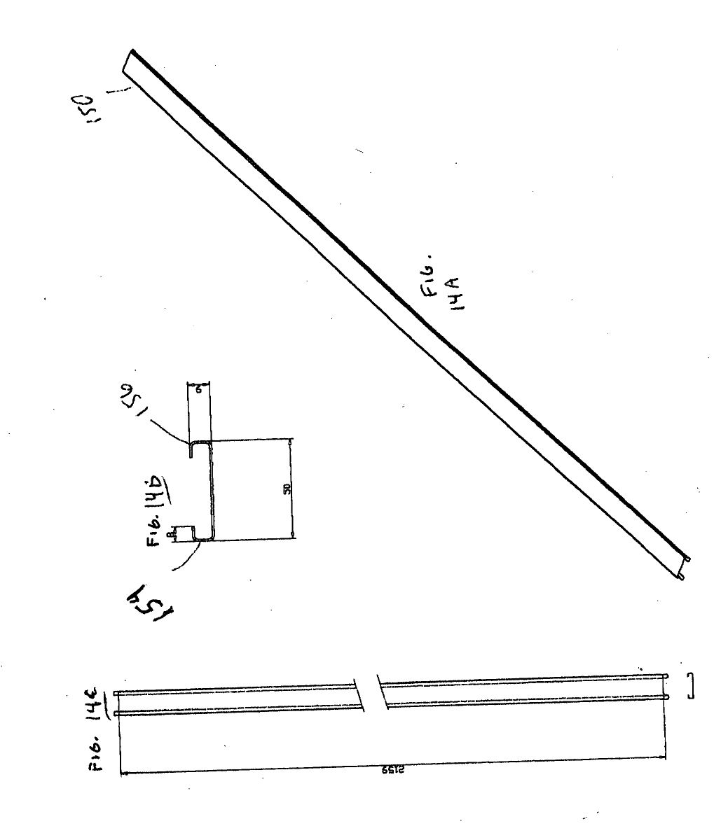

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

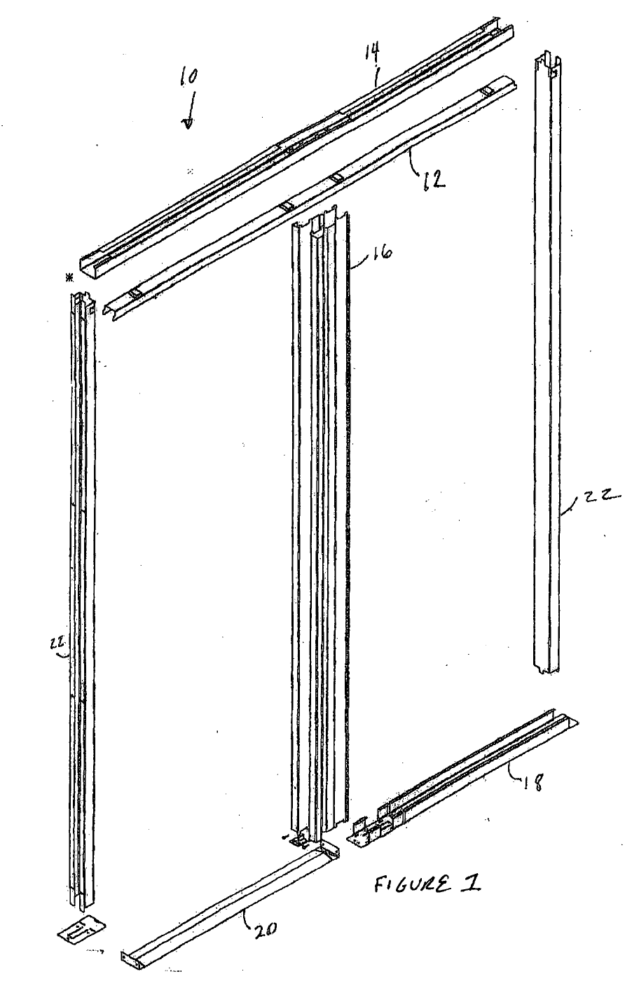

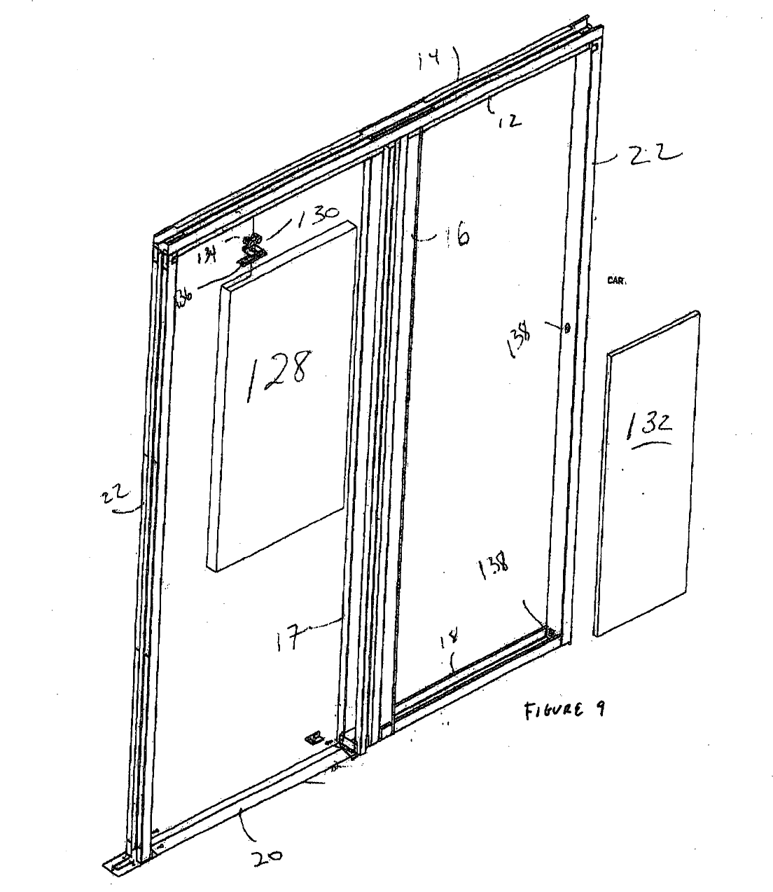

FIG. 1 depicts a pre-fabricated sliding door assembly 10. As shown, the door assembly 10 a first upper track piece 12, a second upper track piece 14, at least two middle support frame pieces 16, a first bottom track piece 18, a second bottom track piece 20, at least one side track piece 22. There is also a door having a wheel assembly fixedly attached along the top of the door (as depicted by wheel assembly 130, shown in FIG. 9). It should be understood that there may be at least two middle support frame pieces, depending on the number of doors, screens, gates or windows you would like to have. For each door, screen, gate or window, it is desirable to have two middle support frame pieces, although, other embodiments are envisioned that may utilize three track pieces to hang two doors. Also, the bottom track piece may be a single piece with two sides, or be made up of two pieces, as shown; a first bottom piece and a second bottom piece.

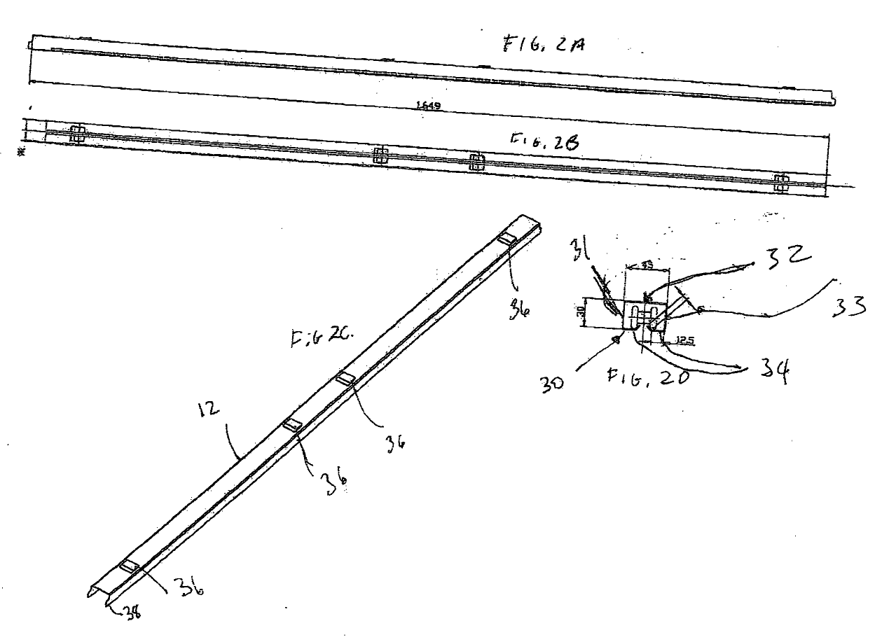

FIGS. 2A-2D depict a first upper track piece 12. FIG. 2D is a side view and depicts the open indented c-shaped longitudinal channel 30, which is comprised of three sides, the top side 32, left side 31 and right side 33, and indented portions 34. There are also at least two attachment devices 36, as shown there are four attachment devices 36. The attachment devices 36, as shown, are cut outs of the first upper track piece 12, which is made of metal, and may be steel. As shown, the open indented c-shaped longitudinal channel 30 does not run the entire length of the first upper track piece 12, as shown in FIG. 2B. Also, the ends have tab protrusions 38 at each end. The term tab protrusions is intended to mean tabs along two sides 31, 33 of the first upper track piece 12 that do not run the entire side (e.g. 31, 33). Also, as shown the top side 32 extends longer on either side than the indented portions 34.

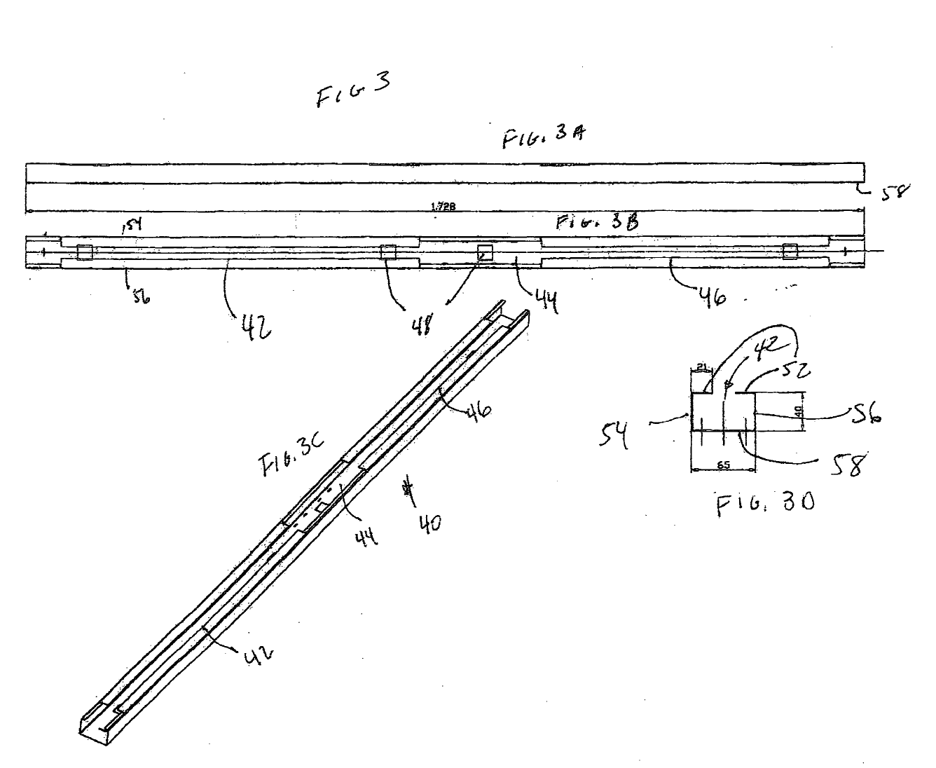

FIGS. 3A-3D depict a second upper track piece 40. The second upper track piece 40 may be suspension track into which the wheel assembly will be inserted and hanging from. As shown, the second upper track piece 40 has a first open c-shaped longitudinal channel portion 42, an open rectangular portion 44 and a second open c-shaped longitudinal channel portion 46 and at least two openings 48 for receipt of the at least two attachment devices 36. As shown, each open c-shaped longitudinal channel portion (e.g. 42, 46) is comprised of two protrusions 52, left side 54, and right side 56, and bottom 58. As shown, the left side 54, right side 56 and bottom are extend the entire length of the channel, whereas the two protrusions 52 end less than two inches from each end of the first open c-shaped longitudinal channel portion 42.

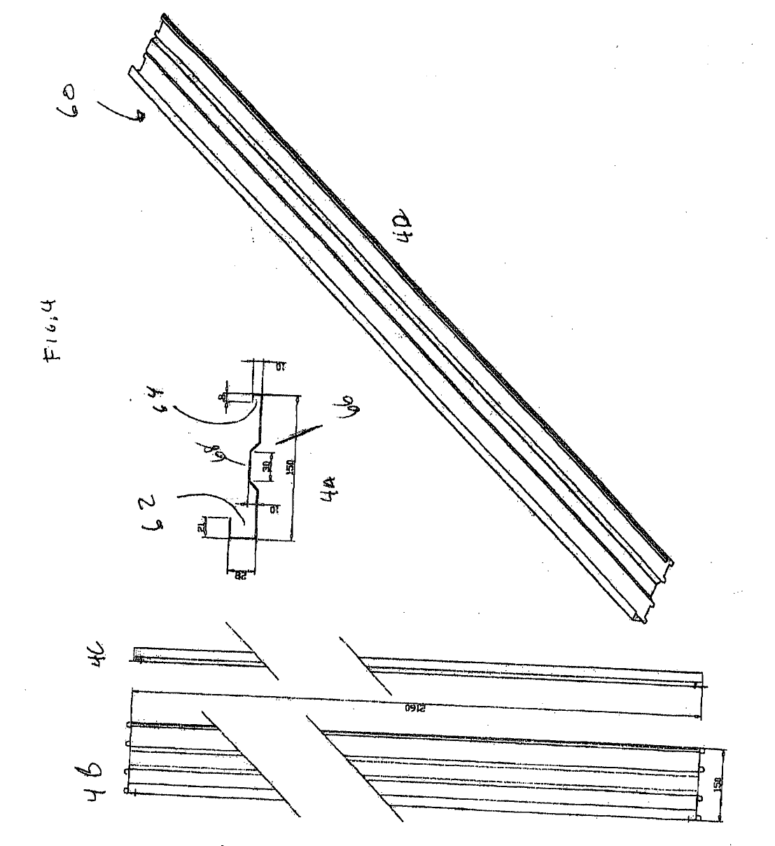

FIGS. 4A-4B depicts a middle support frame piece 60. As shown, there is a first open rectangular channel 62 and a second open rectangular channel 64. It should be understood that there may be a first open rectangular channel. However, the existence of the second open rectangular channel 64 may add stability to the wall panel. The first open rectangular channel 62 is parallel to the opening of second open rectangular channel 64. There is a side portion 66. The side portion 66 may also have a raised portion 68. As shown, the first open rectangular channel 62, second open rectangular channel 64 and raised portion 68 are all raised on the same side and the side portion 6 is substantially flat. Also, the first open rectangular channel 62 and the second open rectangular channel 64 are of dissimilar sizes. The wall panel is inserted into the first channel 62 and fits between the first open rectangular channel 62 and another wall panel in a vertical position to provide a wall panel. This provides an almost seamless transition between the frame and the wall/sheetrock material itself. The term wall panel, according to the present invention may be sheet rock. Also the wall panel may be plywood, wood, plaster, fiberglass, glass or metal alloy.

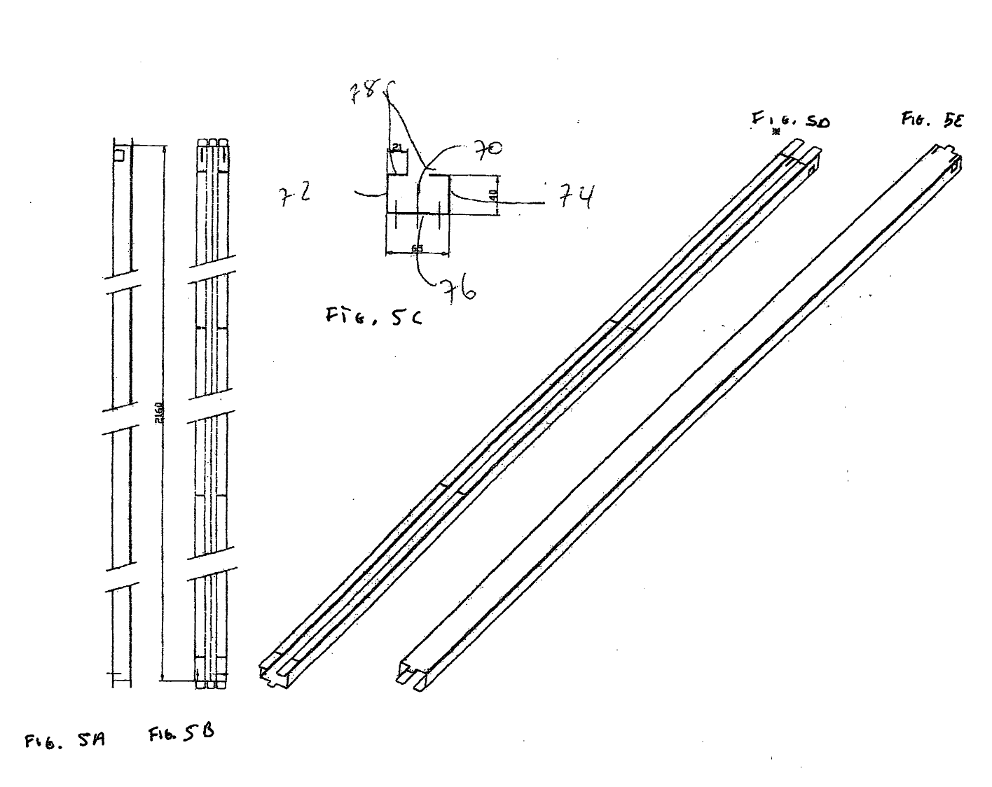

FIGS. 5A-5E depicts a side track piece having an open c-shaped longitudinal channel 70 made up of left side 72, bottom side 76, right side 74, protrusions 78. Each at least one side track piece is perpendicularly attached to first upper track piece 12 and a bottom track piece (either the first bottom track piece or second bottom track piece).

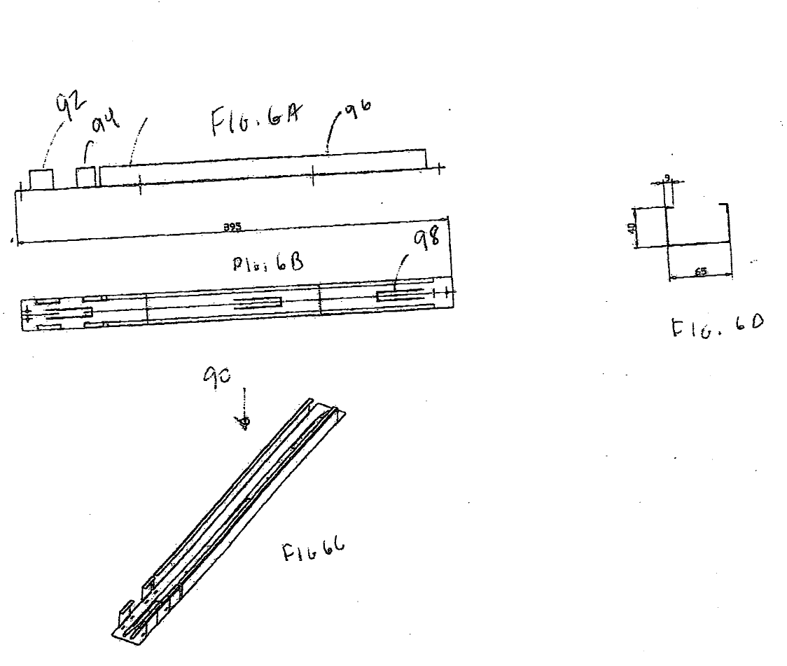

FIGS. 6A-6D depict a first bottom track piece 90, the first bottom track piece 90 having at least two open c-shaped longitudinal channel portions, as shown there are three open c-shaped longitudinal channel portions. The first open c-shaped longitudinal channel portion 92 and the second open c-shaped longitudinal channel portion 94 are less than two inches and the third open c-shaped longitudinal channel portion 96 is at least one foot. The first open c-shaped longitudinal channel portion 92 and the second open c-shaped longitudinal channel portion 94 hold the middle support frame piece in an upright, perpendicular position. As shown in FIG. 6B there may be metal attachment devices, in the form of tongue shaped cut-outs 98. The tongue shaped cut-outs 98 may be folded upwards to contain a track piece. Screws, bolts and attachment pins maybe used as fastening reinforcements for applications that need additional support. However, for most common applications, no extra-fastening device or tools will be necessary.

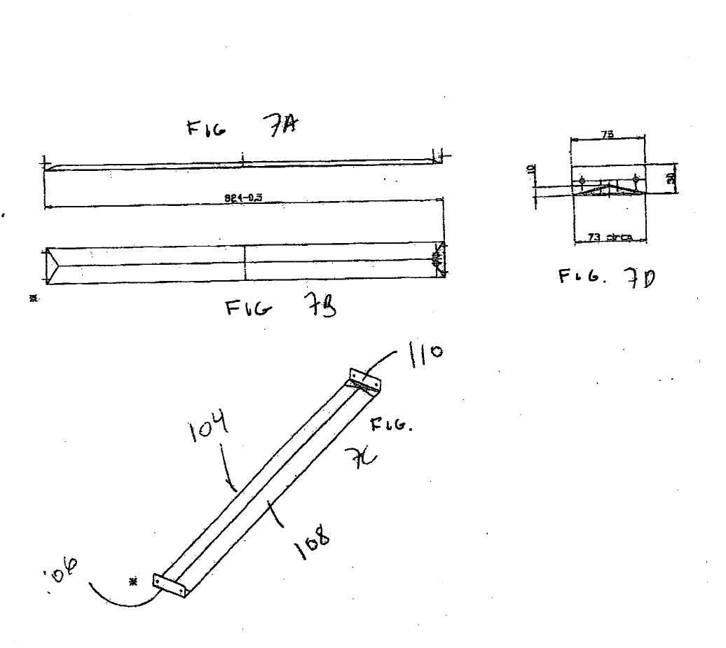

FIGS. 7A-7D depict a side view of a second bottom track piece 104. The second bottom track piece 104 has a left lip 106, middle doorway portion 108, right lip 110, wherein the left lip 106 and the right lip 110 are perpendicular to the middle doorway portion 108. As shown in FIG. 7D, the middle doorway portion 108 may be an open triangle shape (meaning a triangle shape, with one side being open). The second bottom track piece is optional and may be used as a spacing device, to be sure the middle support frame pieces 16 and side track piece 22 are the proper distance apart.

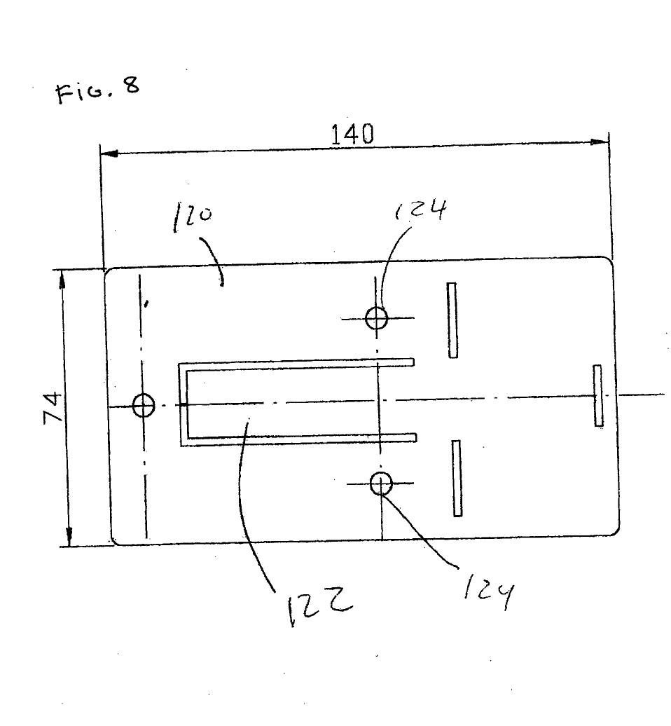

FIG. 8 depicts a metal attachment device 120. The metal attachment device 120 has a tongue shaped 122 cut out and three screw holes 124. Again, it is not necessary to use the screws or bolts, except for high traffic or heavy duty applications.

FIG. 9 depicts a pre-fabricated door assembly, as assembled, and including a door 128, having a wheel assembly 130 attachment means fixedly attached along the top of the door 128. Also shown is a panel 132. It is envisioned that there may be a number of different types of attachment means however, the wheel assembly as shown is a preferred embodiment. The first upper track piece 12 receives the wheel assembly 130, which slides along the first upper track piece 12 and between said at least two middle support frame piece to provide a sliding door. The wheel assembly 130 is comprised of at least one wheel 134 and a hanging wheel attachment means 136. There may also be at least one bumper 138 along at least one side track piece. As shown, the middle support frame pieces 16, 17 are fixedly attached between the first upper track piece 12, first bottom track piece 18 and second bottom track piece 20. Each side track piece 22 is fixedly attached between the first upper track piece 12 and a bottom track piece (e.g. 18 or 20) and wherein the wheel assembly 130 slides along the first upper track 12 piece and between the first middle support frame piece 16 and second middle support frame piece 17 to provide a sliding door.

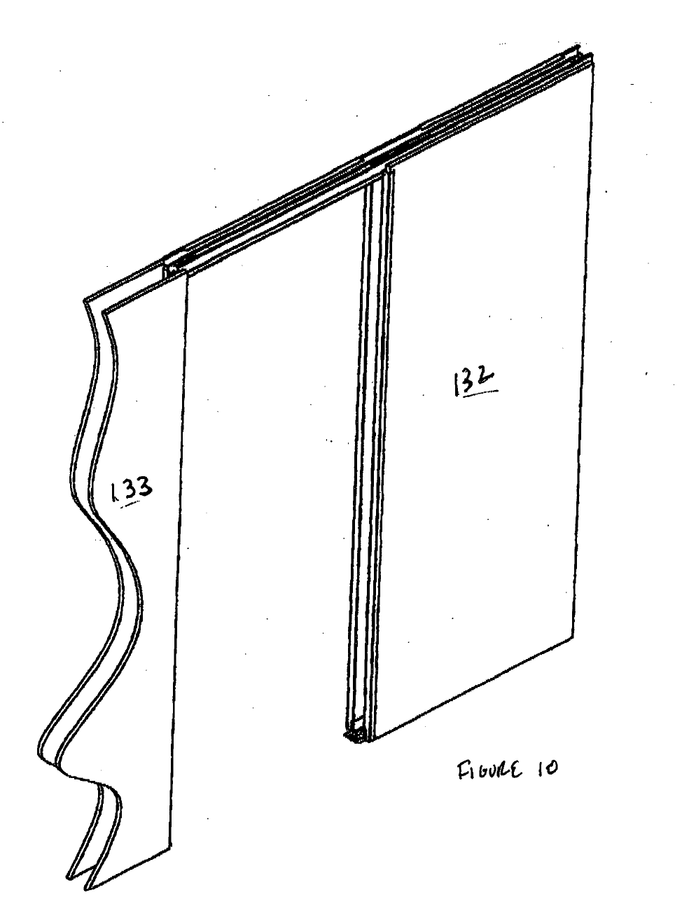

FIG. 10 depicts a cut away side view of a door assembly with the wall panels (132, 133) in place. As shown, the door assembly is barely visible, as the wall panels slide into place and cover the parts of the wall assembly. The wall panel 132, fits into the first open rectangular channel 62 and rests upon second open rectangular channel 64 which is not visible as it is behind wall panel 132.

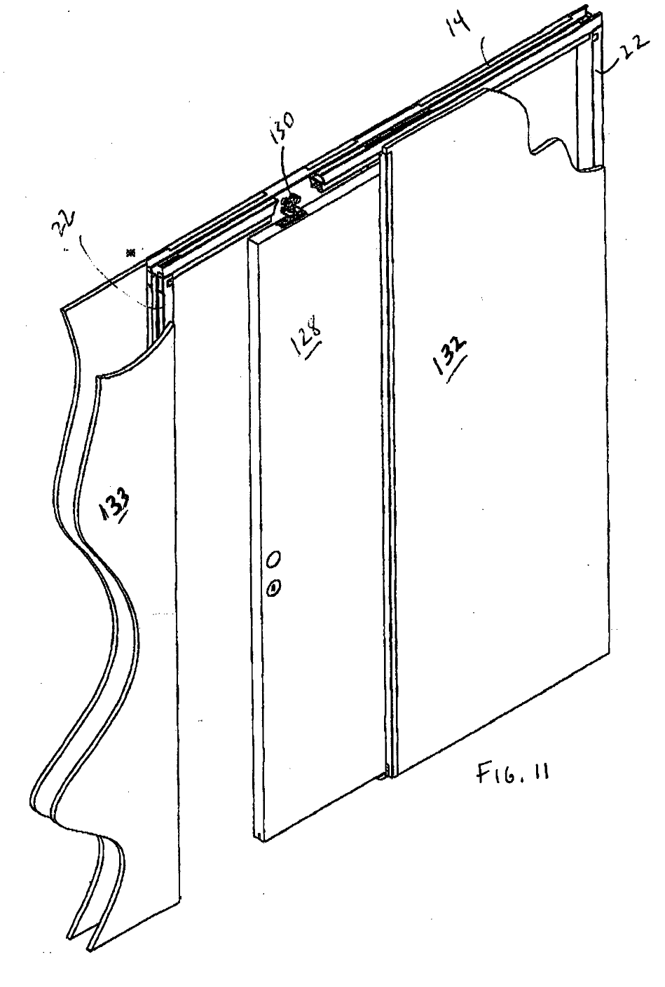

FIG. 11 depicts a cut away side view of a door assembly with the door 128 and wall panels (132, 133) in place. As shown, the door 128 may between two wall panels (e.g. 132). The second wall panel may be on the other side of wall panel 132 and parallel, as to provide a wall and a door that fits in between the wall panels.

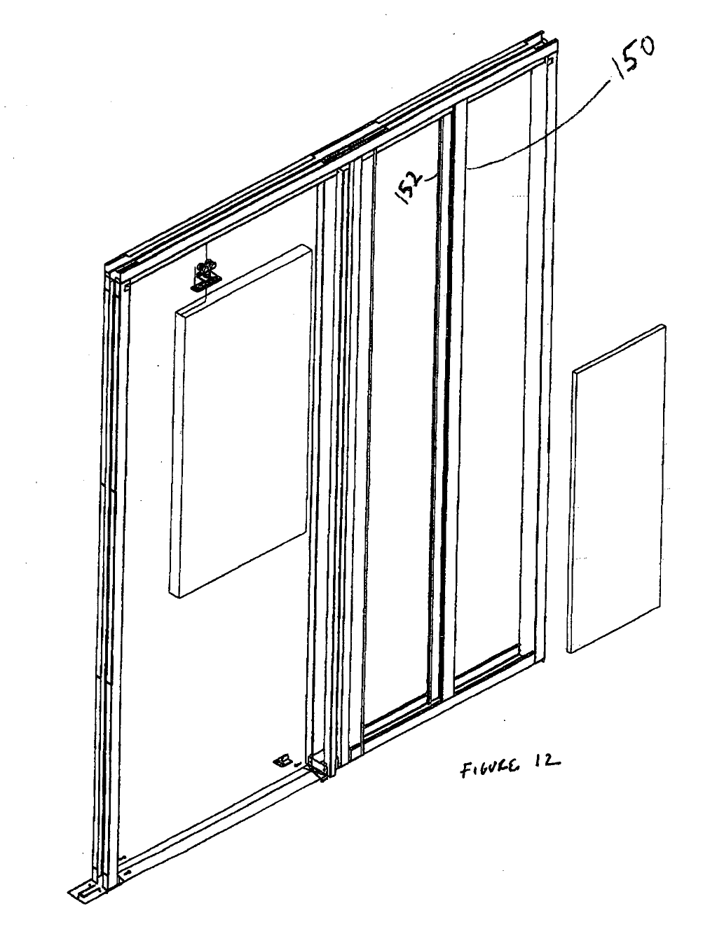

FIG. 12 depicts a side view of a door assembly with two supplemental supports (150, 152) between the middle support frame pieces 16 and the side track piece 22. Supplemental supports may be required under some code and building requirements. For example, it may be required that there be a support every 18 inches of dry wall. In this event, supplemental support 150, 152 may be desirable. Also, they may be desirable for commercial applications or any application were additional strength is required.

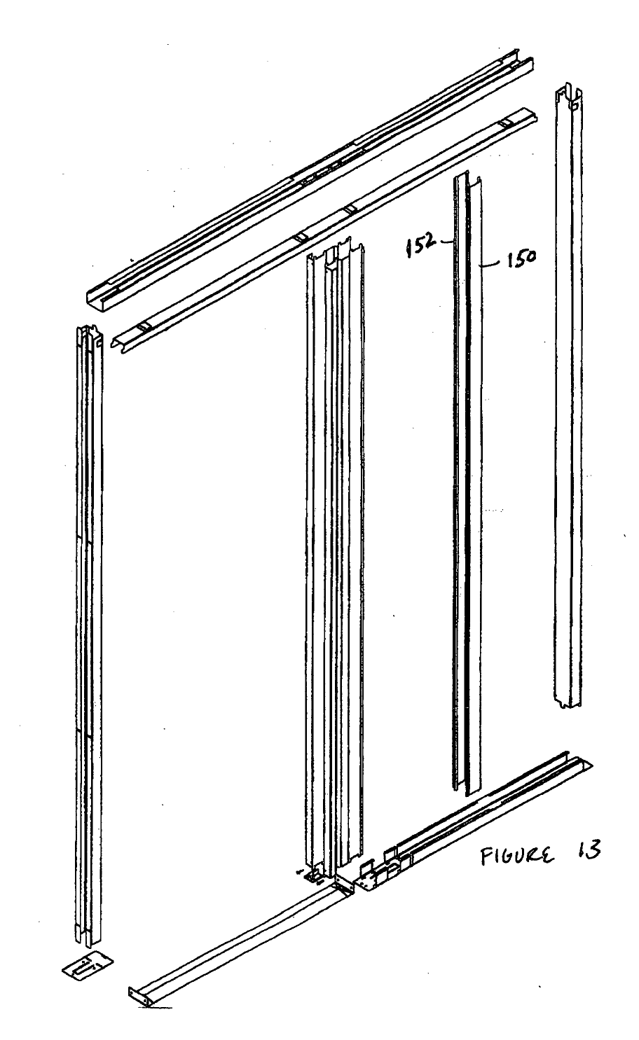

FIG. 13 depicts an exploded side view of a door assembly with showing two supplemental supports 150, 152 between the middle support frame pieces and the side track piece.

FIGS. 14A-14C depicts an elevational view of supplemental supports 150, 152. As shown, the supplement support may have a first lip 154 and a second lip 156. In this manner, the supplemental support may be easily attached to the first upper track piece 12 and first bottom track piece 18.

It should be understood, of course, that the foregoing relates to preferred embodiments of the invention and that modifications may be made without departing from the spirit and scope of the invention as set forth in the following claims.

I claim:

1. A pre-fabricated sliding door assembly, said door assembly comprising:
a first upper track piece having an open indented c-shaped longitudinal channel and at least two attachment devices;
a second upper track piece having a first open c-shaped longitudinal channel portion, an open rectangular portion and a second open c-shaped longitudinal channel portion and at least two openings for receipt of said at least two attachment devices;
at least two middle support frame pieces each having a first open rectangular channel;
a bottom track piece, said first bottom track piece having at least two open c-shaped longitudinal channel portions and a middle doorway portion;
at least one side track piece, wherein said at least one side track piece has an open c-shaped longitudinal channel, and each said at least one side track piece is perpendicularly attached to said first upper track piece and said first bottom track piece;
a door having an attachment means fixedly attached along the top of said door;
wherein each said at least two middle support frame pieces is fixedly attached between said first upper track piece, said first bottom track piece and said second bottom track piece,
wherein each said at least one side track piece is fixedly attached between said first upper track piece and a bottom track piece, and
wherein said wheel assembly slides along said first upper track piece and between said at least two middle support frame piece to provide a sliding door.

2. A pre-fabricated sliding door assembly as in claim 1, wherein said open indented c-shaped longitudinal channel is comprised of a top side, left side, right side and indented portion.

3. A pre-fabricated sliding door assembly as in claim 2, wherein said top side extends longer on either side than said indented portion.

4. A pre-fabricated sliding door assembly as in claim 1, wherein said first open rectangular channel and said second open rectangular channel are of dissimilar sizes.

5. A pre-fabricated sliding door assembly as in claim 1, wherein said bottom portion is comprised of a first bottom track piece and a second bottom track piece, said first bottom track piece having at least two open c-shaped longitudinal channel portions and said second bottom track piece has a left lip, middle doorway portion, right lip, wherein said left lip and said right lip are perpendicular to said middle doorway portion.

6. A pre-fabricated sliding door assembly as in claim 1, further comprising at least one wall panel.

7. A pre-fabricated sliding door assembly as in claim 6, wherein said at least one wall panel is sheetrock, plywood, wood, plaster, fiberglass, glass, metal alloy or any combination thereof.

8. A pre-fabricated sliding door assembly as in claim 1, further comprising a second open rectangular channel, said opening of said first open rectangular channel being parallel to said opening of said second open rectangular channel.

9. A pre-fabricated sliding door assembly as in claim 1, further comprising a least one tongue shaped metal attachment device.

10. A pre-fabricated sliding door assembly as in claim 1, wherein said attachment means is a wheel assembly comprised of at least one wheel and a hanging wheel attachment means.

11. A pre-fabricated sliding door assembly as in claim 1, further comprising at least one bumper along said at least one side track piece.

12. A pre-fabricated sliding door assembly as in claim 1, wherein said at least two attachment devices are raised shaped cut-outs.

13. A pre-fabricated sliding door assembly as in claim 1, wherein at least one end of each said at least one side track piece has a tongue shaped cut-out.

14. A pre-fabricated sliding door assembly as in claim 1, wherein said first bottom piece has at least one tongue shaped cut out.

15. A pre-fabricated sliding door assembly as in claim 1, wherein said middle doorway portion of said second bottom piece is an open triangle shape.

16. A pre-fabricated sliding door assembly as in claim 1, wherein said first bottom track piece has a first open c-shaped longitudinal channel portion, a second open c-shaped longitudinal channel portion and a third open c-shaped longitudinal channel portion, wherein said first open c-shaped longitudinal channel portion is at least one foot long and said second open c-shaped longitudinal channel portion and said third open c-shaped longitudinal channel portion are less than two inches.

17. A pre-fabricated sliding door assembly as in claim 1, further comprising a supplemental support between said middle support frame pieces and said side track piece.

18. A pre-fabricated sliding door assembly, said door assembly comprising:
a first upper track piece having an open indented c-shaped longitudinal channel and at least two attachment devices, wherein said at least two attachment devices are raised shaped cut-outs;
a second upper track piece having a first open c-shaped longitudinal channel portion, an open rectangular portion and a second open c-shaped longitudinal channel portion and at least two openings for receipt of said at least two attachment devices;
at least two middle support frame pieces each having a first open rectangular channel and a second open rectangular channel, said opening of said first open rectangular channel being parallel to said opening of said second open rectangular channel and of a dissimilar size opening;
a first bottom track piece, said first bottom track piece having at least two open c-shaped longitudinal channel portions;
a second bottom track piece, said second bottom track piece has a left lip, middle doorway portion, right lip, wherein said left lip and said right lip are perpendicular to said middle doorway portion;
at least one side track piece, wherein said at least one side track piece has an open c-shaped longitudinal channel and at least one tongue shaped cut out, and each said at least one side track piece is perpendicularly attached to said first upper track piece and said first bottom track piece;
a door having a wheel assembly fixedly attached along the top of said door;
at least one wall panel, wherein one side of said at least one wall panel is contained within said first open rectangular channel to form a wall;
a supplemental support between said middle support frame pieces and said side track piece;
wherein each said at least two middle support frame pieces is fixedly attached between said first upper track piece, said first bottom track piece and said second bottom track piece,
wherein each said at least one side track piece is fixedly attached between said first upper track piece and a bottom track piece, and
wherein said wheel assembly slides along said first upper track piece and between said at least two middle support frame piece to provide a sliding door.

19. A pre-fabricated sliding door assembly as in claim 18, wherein said at least one wall panel is sheetrock, plywood, wood, plaster, fiberglass, glass, metal alloy or any combination thereof.

20. A pre-fabricated sliding door assembly as in claim 18, further comprising a least one tongue shaped metal attachment device.

21. A pre-fabricated sliding door assembly as in claim 18, wherein said wheel assembly is comprised of at least one wheel and a hanging wheel attachment means.

22. A pre-fabricated sliding door assembly as in claim 18, further comprising at least one bumper along said at least one side track piece.

23. A pre-fabricated sliding door assembly as in claim 18, wherein said first bottom piece has at least one tongue shaped cut out.

24. A pre-fabricated sliding door assembly as in claim 18, wherein said middle doorway portion of said second bottom piece is an open triangle shape.

25. A pre-fabricated sliding door assembly as in claim 18, wherein said first bottom track piece has a first open c-shaped longitudinal channel portion, a second open c-shaped longitudinal channel portion and a third open c-shaped longitudinal channel portion, wherein said first open c-shaped longitudinal channel portion is at least one foot long and said second open c-shaped longitudinal channel portion and said third open c-shaped longitudinal channel portion are less than two inches.

26. A pre-fabricated sliding door assembly, said door assembly comprising:
a first upper track piece having an open indented c-shaped longitudinal channel and at least two attachment devices, wherein said at least two attachment devices are raised shaped cut-outs;
a second upper track piece having a first open c-shaped longitudinal channel portion, an open rectangular portion and a second open c-shaped longitudinal channel portion and at least two openings for receipt of said at least two attachment devices;
at least two middle support frame pieces each having a first open rectangular channel and a second open rectangular channel, said opening of said first open rectangular channel being parallel to said opening of said second open rectangular channel and of a dissimilar size opening;
a first bottom track piece, said first bottom track piece having at least two open c-shaped longitudinal channel portions;
a second bottom track piece, said second bottom track piece has a left lip, middle doorway portion, right lip, wherein said left lip and said right lip are perpendicular to said middle doorway portion;
at least one side track piece, wherein said at least one side track piece has an open c-shaped longitudinal channel and at least one tongue shaped cut out, and each said at least one side track piece is perpendicularly attached to said first upper track piece and said first bottom track piece;
at least one bumper along said at least one side track piece;
a door having a wheel assembly fixedly attached along the top of said door, said wheel assembly comprised of at least one wheel and a hanging wheel attachment means;
at least one tongue shaped metal attachment device;
at least one wall panel, wherein at one side of said at least one wall panel is contained within said first open rectangular channel to form a wall;
wherein each said at least two middle support frame pieces is fixedly attached between said first upper track piece, said first bottom track piece and said second bottom track piece,
wherein each said at least one side track piece is fixedly attached between said first upper track piece and a bottom track piece, and
wherein said wheel assembly slides along said first upper track piece and between said at least two middle support frame piece to provide a sliding door.

27. A pre-fabricated sliding door assembly as in claim 26, wherein said at least one wall panel is sheetrock, plywood, wood, plaster, fiberglass, glass or metal alloy.

28. A pre-fabricated sliding door assembly as in claim 26, wherein said first bottom piece has at least one tongue shaped cut out.

29. A pre-fabricated sliding door assembly as in claim 26, wherein said middle doorway portion of said second bottom piece is an open triangle shape.

30. A pre-fabricated sliding door assembly as in claim 26, wherein said first bottom track piece has a first open c-shaped longitudinal channel portion, a second open c-shaped longitudinal channel portion and a third open c-shaped longitudinal channel portion, wherein said first open c-shaped longitudinal channel portion is at least one foot long and said second open c-shaped longitudinal channel portion and said third open c-shaped longitudinal channel portion are less than two inches.

31. A pre-fabricated sliding door assembly as in claim 26, further comprising a supplemental support between said middle support frame pieces and said side track piece.
